(19) United States
(12) Patent Application Publication
(10) Pub. No.: US 2006/0209080 A1
(43) Pub. Date: Sep. 21, 2006

(54) Memory management for mobile terminals with limited amounts of graphics memory

(75) Inventors: Mathias Ohlsson, Malmo (SE); Per Thorell, Lund (SE)

Correspondence Address: ERICSSON INC., 6300 LEGACY DRIVE, M/S EVR C11, PLANO, TX, 75024, US

(73) Assignee: Telefonaktiebolaget L M Ericsson (publ)

(21) Appl. No.: 11/083,854

(22) Filed: Mar. 18, 2005

(51) Int. Cl. G06F 12/02

(52) U.S. Cl. 345/543

(57) ABSTRACT

Method and system are disclosed for more efficiently managing the dedicated graphics memory in mobile terminals that have a limited amount of dedicated graphics memory. In one implementation, the display of the mobile terminal is configured as an active area surrounded by a static area. Only the active area is updated on a frequent basis instead of the entire display, thus freeing up space in the dedicated graphics memory. In another implementation, an area of the dedicated graphics memory corresponding to a certain application or display frame buffer is moved to an external memory and only a refresh buffer is maintained for that application or display frame buffer in the dedicated graphics memory. Depending on the size of the refresh buffer, significant space may be freed up in the dedicated graphics memory. This Abstract is submitted with the understanding that it will not be used to interpret or limit the scope or meaning of the claims.

### FIELD OF THE INVENTION

The present invention relates generally to memory management and, more particularly, but not by way of limitation, to memory management for mobile terminals that have a limited amount of dedicated graphics memory.

### BACKGROUND OF THE INVENTION

Handheld electronic devices in general and mobile terminals in particular are being designed with an ever increasing array of graphical capabilities and graphics-related features. For example, most mobile terminals (e.g., cellular phones, personal digital assistants (PDA), etc.) now have digital picture/video capture and playback capability. Smart phones, which are a combination of a cellular phone and a PDA, allow users to view photos, play videos, and even participate in full color (i.e., 16-bit color) video telephony sessions. Going forward, it is expected that such mobile terminals will continue to provide improved photo and video viewing capability, with even richer colors (e.g., 24-bit color) and larger displays (e.g., 240×320 pixels).

Richer colors and/or larger displays, however, require a larger amount of graphics memory (e.g., graphics RAM (GRAM)). For example, a 320×240 pixel display with 16-bit colors is easily supported by a mobile terminal that has, say, 160 Kbytes of GRAM. However, the same 160 Kbytes of GRAM would not be able to accommodate a 320×240 pixel display with 24-bit colors. Adding more GRAM to the mobile terminal, unfortunately, will increase the price of the mobile terminal and may not always be practical due to design considerations. Thus, in mobile terminals where the amount of dedicated graphics memory is limited, it is desirable to provide a more efficient way of managing the graphics memory so that larger displays and/or richer colors may be supported.

### SUMMARY OF THE INVENTION

The present invention is directed to a method and system for more efficiently managing the dedicated graphics memory in mobile terminals that have a limited amount of dedicated graphics memory. In one implementation, the display of the mobile terminal is configured as an active area surrounded by a static area. Only the active area is updated on a frequent basis instead of the entire display, thus freeing up space in the dedicated graphics memory. In another implementation, an area of the dedicated graphics memory corresponding to a certain application or display frame buffer is moved to an external memory and only a refresh buffer is maintained for that application or display frame buffer in the dedicated graphics memory. Depending on the size of the refresh buffer, significant space may be freed up in the dedicated graphics memory.

In general, in one aspect, the invention is directed to a method of managing dedicated graphics memory in a mobile terminal, where the mobile terminal has a display and a predetermined amount of dedicated graphics memory. The method comprises the step of defining a first area in said display, said first area occupying only a portion of said display. The method additionally comprises the steps of allocating a first area memory for said first area in said dedicated graphics memory and updating said first area in said display using said first area memory. Areas of said display that are outside said first area, however, are not updated. The method further comprises the steps of deallocating said first area memory from said dedicated graphics memory and defining a second area in said display different from said first area, said second area occupying only a portion of said display. A second area memory is then allocated for said second area in said dedicated graphics memory, said second area memory occupying substantially the same part of said dedicated graphics memory as said first area memory. Said second area in said display is then updated using said second area memory, with areas of said display outside said second area not being updated. Said second area memory is then deallocated from said dedicated graphics memory

In general, in another aspect, the invention is directed to a central processing unit in a mobile terminal for controlling a display of the mobile terminal. The central processing unit comprises a processor, a dedicated graphics memory connected to the processor, and a display controller connected to the dedicated graphics memory. The central processing unit is configured to define a first area in said display, said first area occupying only a portion of said display. The central processing unit is additionally configured to allocate a first area memory for said first area in said dedicated graphics memory and update said first area in said display using said first area memory. Areas of said display that are outside said first area, however, are not updated. The central processing unit is further configured to deallocate said first area memory from said dedicated graphics memory and define a second area in said display different from said first area, said second area occupying only a portion of said display. A second area memory is allocated for said second area in said dedicated graphics memory, said second area memory occupying substantially the same part of said dedicated graphics memory as said first area memory. Said second area is updated in said display using said second area memory, with areas of said display outside said second area are not updated. Said second area memory is then deallocated from said dedicated graphics memory.

In general, in yet another aspect, the invention is directed to a method of managing dedicated graphics memory in a mobile terminal, where the mobile terminal has a display, an external memory, and a predetermined amount of dedicated graphics memory. The method comprises the steps of moving display information for an application running on the mobile terminal from the dedicated graphics memory to the external memory and replacing the display information with refresh information corresponding to the display information in the dedicated graphics memory, with the refresh information occupying less of the dedicated graphics memory than the display information. The method further comprises the steps of copying the display information from the external memory back to the dedicated graphics memory one block at a time, the block having a predetermined size, and updating the display one block at a time using the display information copied back from the external memory.

In general, in still another aspect, the invention is directed to a central processing unit in a mobile terminal for controlling a display of the mobile terminal. The central processing unit comprises a processor, a dedicated graphics memory connected to the processor, and a graphics and display controller connected to the dedicated graphics memory. The central processing unit is configured to move display information for an application running on the mobile terminal from the dedicated graphics memory to an external memory and replace the display information with refresh information corresponding to the display information in the dedicated graphics memory, the refresh information occupying less of the dedicated graphics memory than the display information. The central processing unit is further configured to copy the display information from the external memory back to the dedicated graphics memory one block at a time, the block having a predetermined size, and update the display one block at a time using the display information copied back from the external memory.

It should be emphasized that the term comprises/comprising, when used in this specification, is taken to specify the presence of stated features, integers, steps, or components, but does not preclude the presence or addition of one or more other features, integers, steps, components, or groups thereof.

### BRIEF DESCRIPTION OF THE DRAWINGS

The foregoing and other advantages of the invention will become apparent from the following detailed description and upon reference to the drawings, wherein:

FIG. 1 illustrates a graphics controller according to embodiments of the invention;

FIG. 2 illustrates a display having an active area and a static area according to embodiments of the invention;

FIG. 3 illustrates another graphics controller according to embodiments of the invention;

FIG. 4 illustrates the movement of display information from a dedicated graphics memory to an external memory according to embodiments of the invention;

FIG. 5 illustrates the movement of the display information back from the external memory to the dedicated graphics memory and subsequently to a display according to embodiments of the invention; and

FIG. 6 illustrates various stages of memory management according to embodiments of the invention.

### DESCRIPTION OF ILLUSTRATIVE EMBODIMENTS OF THE INVENTION

As mentioned above, embodiments of the invention provide a system and method for managing the graphics memory in mobile terminals that have a limited amount of dedicated graphics memory.

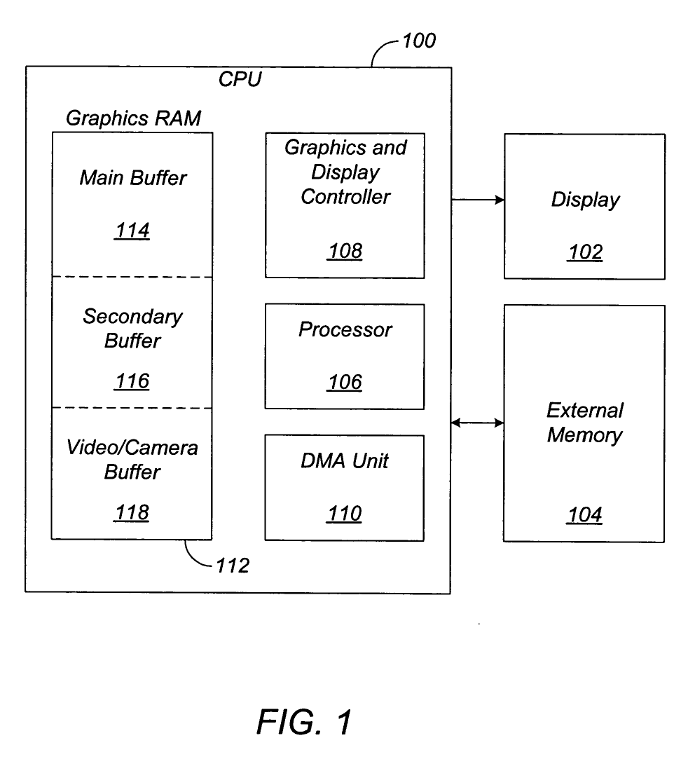

FIG. 1 shows a central processing unit (CPU) system 100 with graphics and display controller in accordance with embodiments of the invention. The CPU 100 is connected to a display 102 for displaying the images and videos that are shown on the mobile terminal, as well as an external memory 104 that serves as a frame buffer for the display 102 in some cases. The display 102 may be any suitable display, including a liquid crystal display (LCD), a plasma display, and the like. Likewise, the external memory 104 may be any suitable memory, including a synchronous DRAM and the like. Although not expressly shown, a second display may also be attached to the CPU 100 in addition to the display 102.

Within the CPU 100 are a number of functional components, including a processor 106, a graphics and display controller 108, a direct memory access unit (DMA) 110, and a dedicated graphics memory 112. These functional components may be implemented as a series of individual, discrete components, or they may be implemented as a single integrated circuit such that the entire CPU 100 is contained on a single chip (i.e., a system on a chip (SOC)). Other techniques for implementing the functional components of the CPU 100 may also be used without departing from the scope of the invention.

Briefly, the processor 106 executes the operating system and any system software needed to operate the CPU 100, including executing the network signaling stack in a mobile terminal and decoding compressed audio files. As part of its operation, the processor 106 can access both the dedicated graphics memory 112 and the external memory 104.

The graphics and display controller 108 controls the display 102, including updating of a specific area of the display 102, by reading display information stored in the dedicated graphics memory 112. Note that the display 102 has its own memory (not expressly shown) such that only portions of the display that have changed need to be updated. When necessary, the graphics and display controller 108 can adapt the bit depth of the dedicated graphics memory 112, or portions thereof, to the bit depth of the display 102. The graphics and display controller 108 can also convert red, blue, and green (RBG) color definition to YUV color definition (and vice versa), where Y is the luminance (brightness) component and U and V are the chrominance (color) components.

The direct memory access 110 is a general purpose device known in the art that can be used for many different types of memory transfers. For example, the direct memory access unit 110 operates to directly transfer large blocks of data between the dedicated graphics memory 112 and the external memory 104. That is, the direct memory access unit 110 transfers display information (as well as other information) without passing the information through the processor 106 first. This results in faster transfer of the display information (as well as other information) compared to the case where the information is transferred by the processor 106.

The graphics and display controller 108, which may be any suitable memory, is preferably a contiguous memory that is divided into several logical blocks. These logical blocks may include, for example, a main buffer 114, a secondary buffer 116, and a video/camera buffer 118. The main buffer 114 may store display information for updating the portion of the display 102 related to, for example, a man-machine interface (MMI). Likewise, the secondary and video/camera buffers 116 and 118 may store display information for updating the portions of the display 102 related to, for example, a camera application and a video application.

In some implementations, the design of the memory access logic in the graphics and display controller 108 may be simplified by restricting memory access to internal graphics memory only. For these implementations, the graphics and display controller 108 may be unable to access external memory, or may be able to do so only with an extra access time penalty. In such situations, the maximum display size and color depth of the display 102 are limited by the size of the dedicated graphics memory 112. Thus, for example, a 24-bit QVGA (320×240 pixel) display cannot be supported in a mobile terminal with a dedicated graphics memory 112 that is limited to, say, 160 Kbytes, at least not using conventional memory management techniques.

The present invention provides a way to support the 24-bit QVGA display with only 160 Kbytes of dedicated graphics memory by more efficiently managing the graphics memory 112. In one implementation, the graphics and display controller 108 may define in the display 102 an active area that will be updated regularly and/or frequently. The remainder of the display 102, which will be referred to herein as a static area, is not updated as regularly or frequently, if at all. Portions of any images or graphics outside of this active area are cropped and not updated.

The active area may be created according to some embodiments of the invention as follows. First, the graphics and display controller 108, via an application running on the processor 106, defines an area in the display 102 to be the active area. The graphics and display controller 108 then allocates a portion of the dedicated graphics memory 112 sufficient for displaying 24-bit QVGA in the active area and stores the 24-bit QVGA display information for the active area in the allocated dedicated graphics memory 112. Display information not within the active area is not stored in the dedicated graphics memory 112 and instead is discarded. Thereafter, the graphics and display controller 108 writes the stored 24-bit QVGA display information to the active area in the display 102. Updates to the active area are also stored in the allocated portion of the graphics and display controller 108 and subsequently written to the same area of the display 102.

To move the active area to another location in the display 102, the graphics and display controller 108 deallocates the portion of the dedicated graphics memory 112 that was allocated for the active area and defines a new active area in the display 102. The graphics and display controller 108 then allocates another portion of the dedicated graphics memory 112 sufficient for displaying 24-bit QVGA in the new active area and stores the new 24-bit QVGA display information for that active area in the allocated dedicated graphics memory 112. The newly allocated portion of the dedicated graphics memory 112 may be identical in size to the previous portion, or it may be different. The new 24-bit QVGA display information is then written to the new active area in the display 102.

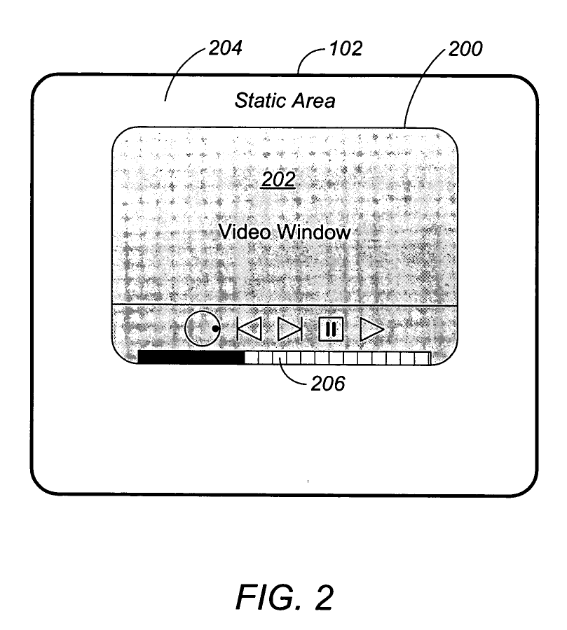

An example of the display 102 being configured to include an active area 200 that is updated regularly and/or frequently is shown in FIG. 2. The active area 200 in this specific embodiment is a video playback window 202 for playing back video clips from, for example, a video application and the like. It should be noted, however, that the active area 200 of the invention is not limited to video playback windows 202 only, but may be defined to occupy any part of the display 102 as needed. A static area 204 surrounds the active area 200 (video window 202) and takes up the remainder of the display 102. Only the active area 200 of the display 102 is updated regularly with new display information, while the static area 204 is not updated regularly.

When implemented as a video playback window 202, the active area 200 is generally not moved around the display 102. In other implementation, however, the active area 200 may be relocated to other parts of the display 102 as needed. When the active area 200 needs to be relocated to a different position within the display 102, the allocated portion of the dedicated graphics memory 112 may be reconfigured in the manner described above to support the relocated active area 200 without changing the amount of allocated dedicated graphics memory 112 required. As a result, it is only necessary to allocate enough dedicated graphics memory 112 to support the active area 200, as opposed to the entire display 102. The use of the active area 200 together with the static area 204 effectively allows the dedicated graphics memory 112 to accommodate a display 102 having a size and/or color depth that is larger than the actual size of the dedicated graphics memory 112, without requiring access to the external memory 104.

The size of the active area 200 may be defined by the applications currently executed in the mobile terminal, with the maximum size of the active area 200 limited by the actual amount of dedicated graphics memory 112 available. Examples of such applications include an MMI, video telephony applications, media players, and other applications where large parts of the display are mainly static and the most frequently updated parts are concentrated within a small area of the display.

In the video playback window 202 example of FIG. 2, the active area 200 and the static area 204 represent the GUI (graphical user interface) for an MMI. For these types of applications, only the video playback window 202, or the portion of the dedicated graphics memory 112 corresponding to the video playback window 202, needs to be updated regularly (typically at a frequency of about 15 Hz). In the present case, the portion of the dedicated graphics memory 112 corresponding to the video playback window 202 is the main buffer 114. The surrounding static area 204, on the other hand, needs to be drawn only once, namely, when the application is first initiated. If status information, such as a progress bar 206, or any other frequently updated features are present, these features are preferably located near the video playback window 202 so that they fit within the video playback window 202.

As alluded to above, the amount of dedicated graphics memory needed for a particular display does not depend solely on the width and height of the display (or of the active area). Color depth also affects the amount of dedicated graphics memory needed. For example, a 24-bit color scheme can represent 65536 (or 2¹⁶) times as many colors as an 8-bit color scheme, but requires three times as much dedicated graphics memory. Conversely, using a lower color depth allows the same size dedicated graphics memory to support nearly the entire display.

In accordance with embodiments of the invention, it is possible to store different color depths for different areas of the display 102, although the actual display 102 itself uses only one color depth. For example, the graphics data for the active area may be stored using a lower color depth (e.g., 8-bit, 4-bit, and 2-bit) than the graphics data for the static area, thus reducing the amount of dedicated graphics memory 112 required. The lower color depth graphics data for the active area in the dedicated graphics memory 112 may then be converted to the higher color depth of the display 102 during refresh by the graphics and display controller 108. Thus, the active will appear to have a lower color depth than the static area, even though the display 102 is using the same color depth for both active and static areas.

Indeed, in the example of FIG. 2, where separate hardware (not expressly shown) is available for handling the video overlay, a 2-bit color scheme (i.e., four colors) may be used for the video playback window 202 during the video playback in order to conserve dedicated graphics memory 112. One of the four colors may be used for the video color, while the remaining colors may be used for drawing text and/or simple icons on top of the video. The video data itself will be shown in full color by virtue of the separate overlay hardware.

In some cases, there may be a difference in the color format of the display information stored in the dedicated graphics memory 112 and the color format of another application. For example, the display information for the MMI (stored in the main buffer 114) may be in the RGB format, while another application (e.g., a camera or video codec) uses the YUV format for the video overlay. When this happens, the video data that is in the YUV format has to be displayed on the active area of the MMI that is in the RGB format.

To solve the above problem, in some embodiments, the graphics and display controller 108 defines a predetermined color in the RGB color space as the “video color.” If a picture element having the same predetermined color is found by the display interface (not expressly shown) during the refresh of the display 102, the graphics and display controller 108 selects a picture element at a corresponding position in the buffer for the other application (e.g., video buffer 116), converts the color information from the YUV color space to RGB format, and transmits the converted picture element to the display 102.

To update the entire display 102, an application running on the processor 106 must update (via the graphics and display controller 108) all the areas that together make up the entire display 102. For example, the application may select a first area of the display 102 as the area to be updated. This area becomes the active area and the application updates the graphic contents in this area. Portions of any image that extend outside of the area selected are not updated. The application may then select a second area of the display 102 to be updated. That area then becomes the active area and the application updates the graphic content of that area/region. This procedure is repeated until all of the areas of the display 102 are updated.

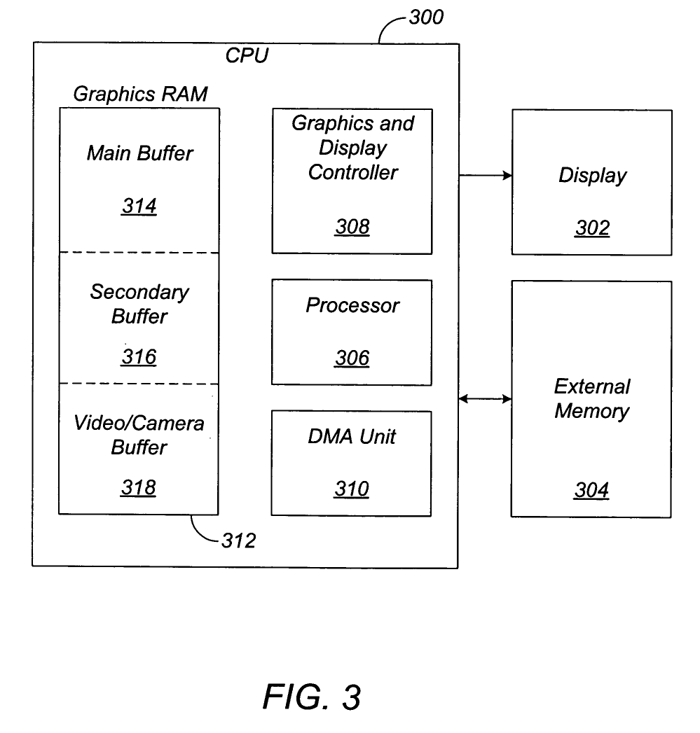

Thus far, the CPU 100 has not needed to access the external memory 104. In some cases, however, the CPU 100 may need to access the external memory 104. An example is shown in FIG. 3, which illustrates a CPU 300 according to embodiments of the invention. The CPU 300 is similar to the CPU 100 of FIG. 1 in that it is connected to a display 302 for displaying the images and videos that are shown on the mobile terminal, as well as an external memory 304 that serves as a frame buffer for the display 302 in some cases. Likewise, within the CPU 300 are a number of functional components, including a processor 306, a graphics and display controller 308, a direct memory access unit (DMA) 310, and a dedicated graphics memory 312. Although not expressly shown, a second display may also be attached to the CPU 300 in addition to the display 302. These functional components are similar to their counterparts in the CPU 100 of FIG. 1 and will not be described in detail here.

The CPU 300 may need to access the external memory 304 when the dedicated memory 312 is too small to support a main display 302 together with a secondary display and at the same time support a third and forth application, such as video and camera functionality, when the display sizes of the applications increases. In a typical scenario, the dedicated graphics memory 312 may need to support a 16-bit QVGA main display buffer 314 (150 Kbytes) and a 16-bit QCIF+alpha (176×220) secondary sub-display display buffer 316 (75 Kbytes), while providing maximum buffer sizes for the video (38 Kbytes) and camera (50 Kbytes) buffer 318. As can be seen, the total amount of dedicated graphics memory 312 required is 313 Kbytes, which exceeds the 160 Kbytes of available dedicated graphics memory 312.

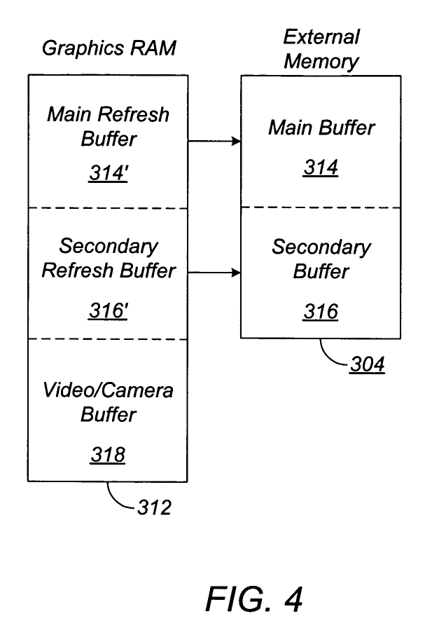

Referring now to FIG. 4, in accordance with embodiments of the invention, the CPU 300 moves the display information in the main and secondary display buffers 314 and 316 to the external memory 304, and maintains only a smaller refresh buffer 314′ and 316′ in the dedicated graphics memory 312 for each display. Depending on how small the refresh buffers 314′ and 316′ are made, it may be possible to fit the video/camera buffer 318 in dedicated graphics memory 312 at the same time as the refresh buffers 314′ and 316′ for both main and secondary displays.

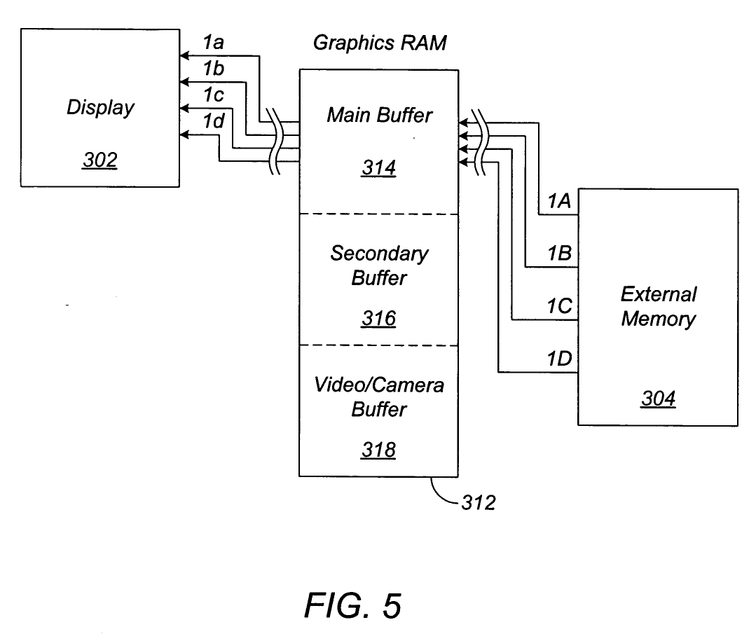

When updating the display 302, the display information from the main and secondary buffers 314 and 316 that was moved to the external memory 304 is copied back to the dedicated graphics memory 312 in standard size blocks and used to update the display 302. The CPU 300 sets the internal video memory pointer in the display 302 to the correct vertical position before updating the first block. This copying is illustrated in FIG. 5, where blocks of display information 1A, 1B, 1C, and 1D in the external memory 304 are copied one at a time back to the dedicated graphics memory 312 so that only one block is present in the dedicated graphics memory at a given moment. The blocks 1A, 1B, 1C, and 1D are subsequently used to update the positions 1a, 1b, 1c, and 1d in the display 302.

Of course, the hardware registers for the video and camera areas will have to be adjusted accordingly in a manner known to persons having ordinary skill in the art. Also, the area to be copied is preferably minimized. For example, if an area starting at column 20 with a height of 100 rows is to be updated, only that block is copied and sent to the display 302.

In some embodiments, the use of the refresh buffers 314′ and 316′ in the dedicated graphics memory 312 may be handled dynamically. Thus, if more dedicated graphics memory 312 is needed, for example, to run the video or camera functions, then the CPU 300 may use a smaller refresh buffer 314′ and 316′ in the dedicated graphics memory 312 until such time when normal refresh operations may resume.

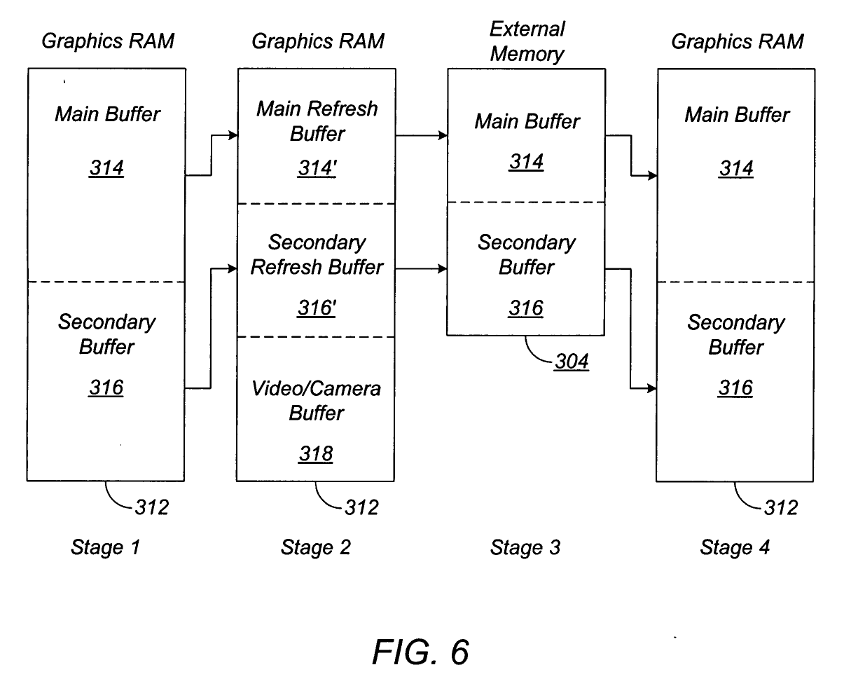

The above adjustment can be seen in FIG. 6, where in stage 1, the CPU 300 detects that more space in the dedicated graphics memory 312 is needed by a third and/or fourth application (e.g., a video/camera application). In stages 2 and 3, the CPU 300 moves the display information for the main and secondary display buffers 314 and 316 to the external memory 304, and maintains only a refresh buffer 314′ and 316′ for each display. This releases some of the dedicated graphics memory 312 for the third and/or fourth application. When the CPU 300 detects that space in the dedicated graphics memory 312 is available, it moves the main and secondary display buffers 314 and 316 from the external memory 304 back to the dedicated graphics memory 312 in stage 4.

Table 1 below illustrates an exemplary allocation of dedicated graphics memory 312 for a 16-bit QVGA main display buffer and a 16-bit QCIF+alpha secondary sub-display buffer, while providing maximum buffer sizes for a video and camera buffer according to embodiments of the invention. As can be seen, moving the main and secondary display buffers to the external memory allows the dedicated graphics memory 312 to accommodate additional applications, thus optimizing the performance of the graphics controller if only a limited amount of dedicated graphics memory is available.

TABLE 1

| | | | Improved | | | |
|---|---|---|---|---|---|---|
| | Conventional | | Dedicated | | External | |
| | Dedicated Memory | | Memory | | Memory | |
| Main Display | 150 | | 38 | | 150 | |
| Secondary display | 75 | | 18 | | 75 | |
| Camera | 50 | | 50 | | — | |
| Video | 38 | | 38 | | — | |
| Total | 313 | Kbytes | 144 | Kbytes | 225 | Kbytes |

While the present invention has been described with reference to one or more particular embodiments, those skilled in the art will recognize that many changes may be made thereto without departing from the spirit and scope of the present invention. Therefore, each of the foregoing embodiments and obvious variations thereof is contemplated as falling within the spirit and scope of the claimed invention, which is set forth in the following claims.

What is claimed is:

1. A method of managing dedicated graphics memory in a mobile terminal, said mobile terminal having a display and a predetermined amount of dedicated graphics memory, comprising:
defining a first area in said display, said first area occupying only a portion of said display;
allocating a first area memory for said first area in said dedicated graphics memory;
updating said first area in said display using said first area memory, wherein areas of said display outside said first area are not updated;
deallocating said first area memory in said dedicated graphics memory;
defining a second area in said display different from said first area, said second area occupying only a portion of said display;
allocating a second area memory for said second area in said dedicated graphics memory, said second area memory occupying substantially the same part of said dedicated graphics memory as said first area memory;
updating said second area in said display using said second area memory, wherein areas of said display outside said second area are not updated; and
deallocating said second area memory in said dedicated graphics memory.

2. The method according to claim 1, wherein said step of updating said first area comprises storing a first area display information in said first area memory and writing said first area display information to said first area in said display.

3. The method according to claim 1, wherein said step of updating said second area comprises storing a second area display information in said second area memory and writing said second area display information to said second area in said display.

4. The method according to claim 1, wherein said step of updating said first area is performed multiple times before said step of defining said second area.

5. The method according to claim 1, wherein said first area is a video playback window that is updated at a predetermined frequency which is higher than an update frequency of other areas of said display.

6. The method according to claim 5, wherein said predetermined frequency is approximately 15 hertz.

7. The method according to claim 2, wherein said first area display information is stored using a lower picture element color depth than other areas of said display.

8. The method according to claim 2, wherein said first area display information is stored using a higher picture element color depth than other areas of said display.

9. The method according to claim 1, wherein said first area uses red, green, and blue (RGB) color space definition, further comprising converting picture elements from a luminance and chrominance (YUV) color space definition to said RGB color space definition.

10. A central processing unit in a mobile terminal for controlling a display of said mobile terminal, comprising:
a processor;
a dedicated graphics memory connected to said processor; and
a display controller connected to said dedicated graphics memory, said central processing unit configured to:
define a first area in said display, said first area occupying only a portion of said display;
allocate a first area memory for said first area in said dedicated graphics memory;
update said first area in said display using said first area memory, wherein areas of said display outside said first area are not updated;
deallocate said first area memory in said dedicated graphics memory;
define a second area in said display different from said first area, said second area occupying only a portion of said display;
allocate a second area memory for said second area in said dedicated graphics memory, said second area memory occupying substantially the same part of said dedicated graphics memory as said first area memory;
update said second area in said display using said second area memory, wherein areas of said display outside said second area are not updated; and
deallocate said second area memory in said dedicated graphics memory.

11. The central processing unit according to claim 10, wherein said central processing unit updates said first area by storing a first area display information in said first area memory and writing said first area display information to said first area in said display.

12. The central processing unit according to claim 10, wherein said central processing unit updates said second area by storing a second area display information in said second area memory and writing said second area display information to said second area in said display.

13. The central processing unit according to claim 10, wherein said central processing unit updates said first area multiple times before defining said second area.

14. The method according to claim 10, wherein said first area is a video playback window that is updated at a predetermined frequency which is higher than an updated frequency of other areas of said display.

15. The central processing unit according to claim 14, wherein said predetermined frequency is approximately 15 hertz.

16. The central processing unit according to claim 11, wherein said central processing unit is further configured to store said first area display information using a lower picture element color depth than other areas of said display.

17. The central processing unit according to claim 11, wherein said central processing unit is further configured to store said first area display information using a higher picture element color depth than other areas of said display.

18. The central processing unit according to claim 10, wherein said first area uses red, green, and blue (RGB) color space definition, said display controller further configured to convert picture elements from a luminance and chrominance (YUV) color space definition to said RGB color space definition.

19. A method of managing dedicated graphics memory in a mobile terminal, said mobile terminal having a display, an external memory, and a predetermined amount of dedicated graphics memory, comprising:
moving display information for an application running on said mobile terminal from said dedicated graphics memory to said external memory;
replacing said display information with refresh information corresponding to said display information in said dedicated graphics memory, said refresh information occupying less of said dedicated graphics memory than said display information;
copying said display information from said external memory back to said dedicated graphics memory one block at a time, said block having a predetermined size; and
updating said display one block at a time using said display information copied back from said external memory.

20. The method according to claim 19, further comprising setting a pointer of said display to a correct position for each block of display information before updating said display with said block.

21. The method according to claim 19, further comprising storing display information for a video function in said dedicated graphics memory.

22. The method according to claim 19, further comprising storing display information for a camera function in said dedicated graphics memory.

23. The method according to claim 19, further comprising moving said display information for said application back from said external memory to said dedicated graphics memory.

24. A central processing unit in a mobile terminal for controlling a display of said mobile terminal, comprising:
a processor;
a dedicated graphics memory connected to said processor; and
a graphics and display controller connected to said dedicated graphics memory, said central processing unit configured to:
move display information for an application running on said mobile terminal from said dedicated graphics memory to an external memory;
replace said display information with refresh information corresponding to said display information in said dedicated graphics memory, said refresh information occupying less of said dedicated graphics memory than said display information;
copy said display information from said external memory back to said dedicated graphics memory one block at a time, said block having a predetermined size; and
update said display one block at a time using said display information copied back from said external memory.

25. The central processing unit according to claim 24, wherein said central processing unit is configured to set a pointer of said display to a correct position for each block of display information before updating said display with said block.

26. The central processing unit according to claim 24, wherein said central processing unit is configured to retrieve display information for a video function from said dedicated graphics memory while said application is running on said mobile terminal.

27. The central processing unit according to claim 24, wherein said central processing unit is configured to retrieve display information for a camera function from said dedicated graphics memory while said application is running on said mobile terminal.

28. The central processing unit according to claim 24, wherein said central processing unit is configured to move said display information for said application back from said external memory to said dedicated graphics memory.
